(19) United States
(12) Patent Application Publication
(10) Pub. No.: US 2008/0287585 A1
(43) Pub. Date: Nov. 20, 2008

(54) Compositions and Reaction Tubes with Improved Thermal Conductivity

(76) Inventor: Larry R. BROWN, Carlsbad, CA (US)

Correspondence Address: AGILENT TECHOLOGIES INC, P.O BOX 7599, BLDG E , LEGAL, LOVELAND, CO, 80537-0599, US

(21) Appl. No.: 11/748,007

(22) Filed: May 14, 2007

(51) Int. Cl. C08K 3/38; B01J 19/00; B01L 3/14; C08K 3/04; C08K 3/08; C08K 3/22; C08K 3/34

(52) U.S. Cl. 524/424; 422/102; 422/240; 524/404; 524/413; 524/430; 524/431; 524/432; 524/440; 525/416

(57) ABSTRACT

The present invention relates generally to the fields of chemistry and molecular biology. More particularly, the present invention relates to thermally-conductive compositions and reaction tubes for chemical- and biochemical-based analytical processing. Compositions and reaction tubes in accordance with the invention comprise at least one plastic and at least one compound having a higher thermal conductivity than the at least one plastic to result in compositions and tubes having increased thermal conductivity when compared to the at least one plastic alone. Such compositions and tubes are capable of facilitating rapid heat transfer in numerous heat transfer applications. The thermally-conductive compositions and reaction tubes are especially suitable for containing reaction constituents during thermal cycling of the polymerase chain reaction (PCR).

### BACKGROUND OF THE INVENTION

1. Field of the Invention

The present invention relates generally to the fields of chemistry and molecular biology. More particularly, the present invention relates to thermally-conductive compositions and reaction tubes for chemical- and biochemical-based analytical processing, where reaction temperature is controlled, maintained, or changed by way of heat transfer. The thermally-conductive compositions and reaction tubes are especially suitable for containing reaction constituents for the polymerase chain reaction (PCR).

2. Description of Related Art

Many chemical and biochemical reactions rely on temperature to facilitate or enable a particular reaction. Heating or cooling of reaction constituents is typically performed by way of transferring energy from a heating or cooling source through a container to a sample until the sample reaches a desired temperature. In chemical or biochemical reactions, if optimum reaction temperatures are not reached or too much time is spent at non-optimum temperatures, inefficiencies in processing may result.

Such inefficiencies include the occurrence of side reactions or the production of unwanted or undesirable products, which may consume or exhaust reagents needed for the reaction or otherwise interfere with the reaction of interest. Valuable energy resources may also be unnecessarily consumed in systems and processes that inadequately or inefficiently use heat transfer for controlling reaction temperature. Additionally, in situations where it is advantageous to obtain results quickly, such as in a clinical setting, improving time to result can prove beneficial. Thus, there are numerous benefits that can be achieved by increasing the efficiencies of processes that rely on heat transfer principles.

Nucleic acid amplification is one such analytical tool that uses the concept of heat transfer for the detection and quantification of nucleic acids in biological samples. Such amplification techniques typically involve isolating relatively small amounts of target nucleic acids in a sample and replicating the nucleic acids to obtain the targets in detectable amounts.

Various nucleic acid amplification techniques are well known in the art, including PCR (polymerase chain reaction, including quantitative polymerase chain reaction or QPCR), SDA (strand displacement amplification), NASBA (nucleic acid sequence-based amplification), LCR (ligase chain reaction), and TMA (transcription mediated amplification) to name a few.

Nucleic acid amplification procedures, such as PCR, typically involve thermal cycling a reaction mixture of sample and reagents to amplify DNA. Very generally, thermal cycling involves incubating a reaction mixture at different temperatures, for various periods of time, then repeating the temperature cycle. In PCR protocols the reaction mixture is typically subjected to temperatures alternating or cycling between high, intermediate, and/or low temperatures. The varied incubation temperatures facilitate and enable, at different stages in the temperature cycle, denaturation of the target nucleic acids, primer hybridization (annealing), and primer extension. After repeatedly subjecting the reaction mixture to multiple temperature cycles (typically about forty or more temperature cycles), sufficient amplification of the target DNA results.

One objective of PCR protocols is to generate an increased number of the target nucleic acid, which is typically initially available in the sample only in a relatively small amount. In such situations, the polymerase chain reaction entails copying the nucleic acid, using the copies to generate additional copies, and so on. Ideal reaction conditions can double the amount of target nucleic acid for each cycle of a PCR protocol. After repeated cycling in a PCR protocol, the amount of target DNA in the reaction vessel can experience exponential growth. Thus, some advantages for optimizing protocol conditions, such as incubation and cycle time, can result in generating optimized levels of target, decreased processing time, increased accuracy in results, and better reproducibility of results.

In particular, with respect to PCR protocols it has been recognized that the change in incubation temperature for the sample should be performed as rapidly as possible throughout the temperature cycling. For each biochemical reaction occurring in the PCR protocol, there is an optimum temperature, typically an optimum range in temperature, to be achieved to maximize the results of the reaction. Accordingly, it would be advantageous to attain the optimum temperature range for each stage of the process as quickly as possible. Doing so will naturally result in spending less time at non-optimum temperatures, which leads to maximized yields of amplified product. In addition, undesirable amplification that might occur at non-optimal temperatures during the change from one temperature of the cycle to another, and which might result in low-fidelity amplification, can be better avoided.

Another benefit of quickly reaching optimum reaction temperatures for each stage of the temperature cycling is a reduction in overall cycle time. In PCR reactions, for example, once an optimum reaction temperature has been reached, the reaction typically is allowed to progress for at least a minimum period of time (i.e., temperature plateau) and any additional time needed to ramp the temperature up or down to reach the optimum reaction temperature range, thus, unnecessarily increases the cycle time. In general, for assays using numerous stages and/or cycles, it is often advantageous to reduce the amount of time needed for each cycle. In particular, for PCR processes, a decrease in overall cycle time would lead to a decrease in overall processing time for nucleic acid amplification. A decrease in overall cycle time can be particularly advantageous in a clinical setting, where obtaining results quickly is important.

Yet another benefit in having better control over temperature cycling can be seen in reproducibility and accuracy of results. For example, in assays where multiple samples are being processed simultaneously and/or by automated means, it is often desirable to subject the samples to the same temperature cycles at the same time. It is ideal when processing multiple samples simultaneously to have the samples experience identical reaction conditions, such as being subjected to a certain temperature range at the same time and/or for a certain period of time. Using reaction tubes with improved thermal conductivity in automated systems can lead to better reproducibility and accuracy of results by contributing to an increase in temperature control.

With respect to PCR protocols, multiple samples are typically processed simultaneously. As is industry standard, 96 PCR sample tubes can be processed simultaneously with the aid of a thermal block configured to have 96 wells arranged in an 8-by-12 rectangular array in combination with a 96-well sample tube tray. Heating and cooling the sample wells (reaction vessels) is achieved through heating and cooling the thermal block, thereby transferring desired temperatures to the samples through the walls of the sample vessel.

Delays in transferring temperature from the heating/cooling block to each sample may not be the same for each and every sample, i.e., a delay in temperature transfer experienced by one sample may not be the same as the delay experienced by another. Thus, the samples may not be subjected to the same temperature at the same time or may not be subjected to the same temperature for the same period of time. Such non-uniformity in temperature can lead to non-uniform results, and in turn can result in a lack of reproducibility in results and/or a decrease in the accuracy of the amplified product quantity. Although such inefficiencies are typically associated with heating/cooling block design, reaction vessels with improved thermal conductivity could help minimize the effect of such inefficiencies.

Thus, a need exists for materials with enhanced heat-transfer capabilities that can be used for reaction vessels in chemical and biochemical reaction processes. Improving the thermal conductivity of such reaction vessels would enhance the efficiency and accuracy of such.

Plastic tubes have become the standard container for the reaction mixture of many chemical and biochemical reactions, including PCR. These tubes are widely available, and they share many characteristics. Some of these characteristics are material composition, volume, size, shape, thin conical walls, and format. PCR instrument manufacturers use these common characteristics by designing thermal systems to interface with these tubes.

The most common format for currently available tubes for PCR and QPCR is the 0.2 ml polypropylene tube. The tubes are available individually or in arrays of: a strip of eight tubes, strip of 12, and rectangular arrays of 24, 48, 96, 384, and 1536 tubes (384 and 1536 are smaller volume tubes). Polypropylene is the most common material because it is non-porous and inert. The arrays of tubes in strips and up to 96 well formats adhere to the industry standard 96 well format, which are suitable for 0.2 ml thermal cycler blocks.

Additionally, quantitative PCR (QPCR) has expanded the use of traditional PCR, by combining an optical detection system to interrogate fluorescent probes, attached to the amplification products. The addition of optical signals provides a way for at least relative quantitation of products produced during PCR. With PCR and standard PCR tubes established, most QPCR instruments have been designed to interface with such standard PCR tubes.

As QPCR thermal instrument systems improve and as biological applications for QPCR analysis evolve, there is a desire for PCR tubes that promote faster thermal cycling. Early thermal systems were bulky, and relatively slow, achieving temperature ramp rates of about 0.5 to 1.0 degrees C. per second. As the ramp rates for thermal systems improve, the sample tube is becoming the most limiting factor for improving the heat transfer between the thermal system and the reaction mixture. As QPCR applications expand beyond the research market and into the applied and diagnostic markets, the desire to obtain QPCR results in less time increases as does the corresponding desire for faster thermal cycling. Some of these applications are related to personal medicine, field sampling for biohazards, and others.

The material composition for many chemical and biochemical test tubes is polypropylene. Standard commercially available PCR or QPCR tubes, for example, are typically injection molded using a high flow formulation of polypropylene. This type of material, like Pro-fax, PD702, polypropylene homopolymer, from Basell North America, Inc., has certain advantages, including being transparent, biologically inert, and relatively easy to establish injection molding processing parameters for thin-walled tube designs. Other suitable polypropylenes include Pro-fax PD 701. The disadvantage of this material, or similar grades of polypropylene, however, is that the material is a good thermal insulator and poor thermal conductor. In fact, there are few solids that are better thermal insulators; felt and cork are two. This high thermal insulation yields a high thermal resistance for heat transfer through the tube wall. Chemical and biochemical reaction processes that rely on thermal cycling, in particular, could benefit from reaction tubes comprising more thermally-conductive materials.

### SUMMARY OF THE INVENTION

To address some of the inefficiencies presented by existing art, reaction tubes having higher thermal conductivity than existing tubes are provided by the present invention. More particularly, the present invention relates to thermally-conductive materials for reaction tubes useful, for example, in chemical and biochemical assays where a rapid change in reaction temperature and/or control of reaction temperature is desired. Further, the present invention relates to thermally-conductive materials for reaction tubes, which may be used in nucleic acid amplification protocols, such as the polymerase chain reaction (PCR).

The present invention provides thermally-conductive compositions comprising plastic and at least one compound for improving the thermal conductivity of the plastic.

Reaction vessels for chemical or biochemical reactions comprising plastic and at least one compound for improving the thermal conductivity of the plastic are also provided.

Another aspect of the present invention includes PCR tubes comprising plastic and at least one compound for improving the thermal conductivity of the plastic.

The thermally-conductive compositions and reaction vessels according to the invention can be used in any application that uses heat transfer to control, maintain, or change the temperature of a chemical or biochemical reaction, such as and including a PCR reaction.

A characteristic of the thermally-conductive materials of the present invention is that the materials do not negatively impact or interfere with the biological samples in the reaction vessel and therefore do not negatively impact chemical or biochemical sample processing or analysis. Further, by using the thermally-conductive materials of the present invention, the speed of any chemical or biochemical reaction employing thermal cycling can be increased, thereby reducing overall reaction time processing for such chemical and biochemical reactions. Indeed, overall reaction time for PCR reactions, in particular, can be improved.

Further, novel tube designs, as described here, have the benefit of improved heat transfer into and out of the reaction mixture, while being capable of maintaining characteristics desired by users, such as an 8 by 12 rectangular format on 9 millimeter centers, biologically inert, transparent, pipette friendly, and supportive for excitation light into and emission light out of the tubes. Certain tubes according to the present invention, when combined with a certain thermal system, may support a fast QPCR cycle time of less than 20 minutes for 40 cycles, for at least some biological reaction mixtures. This fast cycle time, combined with other favorable characteristics, may be an attractive combination for applied markets such as personal medicine, environmental testing for biohazards, or others.

### BRIEF DESCRIPTION OF THE DRAWINGS

The accompanying drawings, which are incorporated in and constitute a part of this specification, illustrate several embodiments of the invention. Together with the written description, these representative embodiments serve to explain certain principles or details of various aspects of the present invention.

FIG. 1A shows a representative reaction vessel according to one embodiment of the invention, a standard tube with cap.

FIG. 1C shows a cross-sectional view of the representative reaction vessel of FIG. 1A, cut along line A-A of FIG. 1B.

FIG. 2 shows a representative reaction vessel according to one embodiment of the invention and, in particular, a strip of 8 tubes.

FIG. 3 shows a representative reaction vessel according to one embodiment of the invention and, in particular, a 96-well plate.

FIG. 4 is a graph comparing QPCR done using standard reagents to QPCR done with thermally-conductive plastic added to standard reagents.

### DETAILED DESCRIPTION OF VARIOUS EMBODIMENTS OF THE INVENTION

Reference will now be made in detail to various exemplary embodiments of the invention, examples of which may also be illustrated in the accompanying drawings. The following detailed description is provided to give the reader a better understanding of certain features and details of embodiments of the invention, and is not to be understood as a limitation on any aspect or feature of the invention as broadly disclosed herein, depicted in the figures, or claimed. It will be readily apparent to those of skill in the art that various other modifications to the present invention may be made without departing from the scope and spirit of the invention.

The compositions according to the present invention comprise plastic and at least one compound having a higher thermal conductivity than the plastic. The resultant compositions have increased thermal conductivity relative to the plastic alone and are capable of facilitating rapid heat transfer in numerous heat transfer applications.

For example, the thermally-conductive materials are useful for reaction vessels for chemical or biochemical reaction processes that use heat exchanging to affect reaction temperature. The term “affect” in this context encompasses terms such as control, influence, maintain, adjust, change, or otherwise have an effect on the temperature of the reaction, such as increasing or decreasing temperature, or resisting an increase or decrease in temperature by maintaining the temperature. Thermal cycling is one such technique that uses heat transfer to heat or cool reaction constituents, as desired, to obtain different reaction temperatures at various times throughout a reaction cycle.

The compositions according to the invention are suitable for manufacturing test tubes with higher thermal conductivity than existing tubes. By using test tubes formulated according to the present invention, improved efficiencies can be obtained in applications relying on the principles of heat transfer to enable certain chemical and biochemical reactions. The inventive compositions are useful for reaction tubes used in thermal cycling processes, especially as fast QPCR tubes.

More particularly, the base material of the inventive compositions, plastic, can be any polymeric material. Likewise, the additive can be any compound or combination of compounds that has a higher thermal conductivity than the plastic. Representative materials that can be used in accordance with the present invention include any plastic and any additive that results in a composition having a thermal conductivity greater than the thermal conductivity of the plastic alone, so long as the resultant composition is compatible with the particular application.

A composition is considered application-compatible if it does not substantially interfere with or inhibit a particular reaction. This is especially the case for PCR reactions. For example, some materials including some plastics may not be compatible with a particular reaction because they may outgas materials from the plastic that interfere with the reaction. Some materials may also not be suitable for a particular reaction because the constituents of the reaction may adhere to the reaction vessel. In particular, in the case of PCR reactions, reaction-compatible compositions include compositions that do not promote the sticking of nucleic acids to the reaction vessel. Reaction-compatible characteristics for compositions for other applications will depend on the particular reaction.

Generally, representative compositions according to the present invention include any combination of plastic and another compound with a higher thermal conductivity. Such compositions allow for increased heat transfer as compared to the plastic alone. Any combination of plastic and thermally-conductive additives is understood to be within the scope of the inventive compositions, so long as the resultant compositions have increased thermal conductivity and any specific characteristics desired for a particular application.

According to the invention, the plastic materials can be any thermoset plastic or thermoplastic polymer. Specific non-limiting examples include polyvinyl chloride (PVC), polyethylene terephthalate (PET), high-density polyethylene (HDPE), low-density polyethylene (LDPE), polypropylene, polystyrene, polycarbonate, polytetrafluoroethylene (PTFE), and acrylonitrile-butadiene-styrene (ABS).

In particular, representative types of plastics that can be used for the compositions of the present invention include polypropylenes, polyethylenes, polyesters, polyacrylics, polyamides, polycarbonates, and vinyl polymers, and combinations thereof.

The formulations of the base material, the preferred base material being polypropylene, are generally associated with characteristics which support the manufacturing process parameters to help achieve thin walls in at least a portion of the tube surface. One of these parameters is density. The general density of molded polypropylene varies from about 0.90 to 1.25 grams per cubic centimeter. For this invention, the formulations of polypropylene favorable for thin walled molding exhibit a density which is near the lower end of this range, or about 0.90 grams per cubic centimeter. Another parameter which supports the preferred polypropylene formulation for this invention is mold flow rate. The general mold flow rate for molded polypropylene is about 20 grams per 10 minutes, as defined by ASTM D1238. For this invention, the mold flow rate is typically higher, at around 30 to 35 grams per 10 minutes, as defined by ASTM D1238.

It is further understood that other base materials, though not specifically disclosed above, are also included within the scope of the invention, so long as the resultant compositions meet the desired functional aspects of a particular application and are characterized by an increase in thermal conductivity relative to the base material alone.

Further, according to the invention, the at least one compound having a higher thermal conductivity than the plastic is any additive that would result in compositions having increased thermal conductivity relative to the plastic alone. Representative examples of high thermal conductivity additives include conductive polypropylene, such as COOLPOLY D1202 (Cool Polymers) and boron nitride powder. Other thermally conductive additives, such as aluminum oxide, titanium oxide, iron oxide, tin oxide, beryllium oxide, zinc oxide, aluminum nitride, boron carbide, silicon carbide, titanium carbide, graphite or carbon fibers, carbon powders, nickel powders, gold or gold coated powders, silver or silver coated powders, or combinations of nickel graphite or nickel gold additives are possible depending on the specific product application. Generally, additives which are metallic, ceramic, or mineral, or combinations thereof, are possible depending on the specific application.

The thermally-conductive additive can be present in the compositions according to the invention either alone or in combination with other additives. Alternative additives, though not specifically disclosed herein, are also considered within the scope of this invention. Such additives may give sufficient thermal conductivity performance but may be less biologically inert than, for example, boron nitride. Depending on the particular application, however, such additives are encompassed by the invention, including materials such as aluminum nitride, aluminum oxide, and beryllium oxide. Again, so long as the plastic, additive, and/or resultant composition selected for a particular application is relatively inert to that application and results in a composition having increased thermal conductivity relative to the plastic alone, such materials, compounds, and compositions are considered part of this invention.

In particular, these kinds of alternative materials are considered, as part of this invention, and each combination may have certain properties which may be suitable for PCR or QPCR instruments serving various product requirements.

The compositions according to the present invention comprise plastic and at least one compound having a higher thermal conductivity than the plastic. The plastic and the additive(s) can be present in the compositions in combined amounts totaling 100% by volume, wherein the additive(s) are present in an amount sufficient to result in a composition having a higher thermal conductivity than that of the plastic alone.

In certain embodiments of the invention, plastic can be present in the compositions in an amount of about 90% or more, by volume, of the total composition and the additive(s) can be present in an amount from about 10% or less, by volume, of the total composition. Alternatively, formulations that contain more than 10%, by volume, of additive are possible. These formulations, however, may result in tube properties which are not optimized for PCR or QPCR applications, due to increased biological reaction interference, reduced tube clarity, or manufacturing process parameters which make thin walls more difficult to mold. There may be other features which are not attractive for such formulations, such as increased tube cost or a reduction in the storage temperature range, for example, if such formulations result in more brittle tubes at low temperatures such as certain refrigeration or freezer temperatures commonly used in industry.

Additional embodiments include compositions comprising plastic in an amount of about 95% or more, by volume, of the total composition and additive(s) in an amount from about 5% or less, by volume, of the total composition. Still further, the compositions can comprise plastic in an amount of about 98% or more, by volume, of the total composition and additive(s) in an amount from about 2% or less, by volume, of the total composition. Yet additional embodiments include compositions comprising plastic in an amount of about 99.5% or more, by volume, of the total composition and additive(s) in an amount from about 0.5% or less, by volume, of the total composition. Of course, any particular value within these stated ranges can be used, without the need for each particular value to be recited specifically herein.

In preferred embodiments, for example, the compositions according to the invention can comprise polyethylene in an amount of about 90% or more, by volume, of the total composition and can comprise the additive(s) in an amount from about 10% or less, by volume, of the total composition. In yet other embodiments, the compositions can comprise polypropylene in an amount of about 90% or more, by volume, of the total composition and can comprise the additive(s) in an amount from about 10% or less, by volume, of the total composition. Further, for example, the compositions can comprise polycarbonates in an amount of about 90% or more, by volume, of the total composition and can comprise the additive(s) in an amount from about 10% or less, by volume, of the total composition.

Further, in preferred embodiments, the compositions can comprise plastic in an amount of about 90% or more, by volume, of the total composition and can comprise boron nitride in an amount from about 10% or less, by volume, of the total composition. Still further, in preferred embodiments, the compositions can comprise plastic in an amount of about 90% or more, by volume, of the total composition and can comprise conductive polypropylene in an amount from about 10% or less, by volume, of the total composition.

In more specific embodiments, the compositions can comprise a high flow polypropylene and at least 0.5% boron nitride powder, by volume. More specifically, such embodiments can comprise high flow polypropylene and from about 0.5% boron nitride powder to about 2% boron nitride powder, by volume, of the total composition. In any embodiment comprising boron nitride powder as the additive, the specific percentage of boron nitride powder present in the composition may be determined based on the product requirements.

Boron nitride powder typically has a thermal conductivity of about 400 to 500 times that of certain polypropylene base materials. Assuming a proportional change in thermal conductivity, the composite tube may have a thermal conductivity which is at least several times that of certain commercial polypropylenes.

A high surface area boron nitride powder form may be desired as the specific grade of boron nitride so that the thermal conductivity of the resultant tube may be maximized for a given percentage of powder added. One such powder would be Boron Nitride Powder, Grade NX1, from General Electric Company. This form of powder has a relatively high surface area for each powder particle. A high surface area may improve the composite thermal conductivity achieved, when combined with polypropylene base material, in the tube design.

Boron nitride powder is especially suitable for chemical- and biochemical-related applications because it is chemically inert, thereby minimizing any biological or chemical interaction with the reaction mixture. Also, boron nitride powder is lubricative, so it does not increase tool wear during injection molding.

Further, with the addition of boron nitride powder, which is white in color, the resultant tube color is mostly transparent, with a slight white color. White tubes, while not desired by many users, because they cannot verify the existence of the reaction mixture through the tube wall, have been shown to increase the emission signal for at least some optic systems with detectors located above the tube. With increasing boron nitride powder concentrations, the tube color will become more white, but still somewhat transparent. Such a formulation enables the thermal conductivity of the tube to increase, and, the emission signal strength may increase, both features of which are beneficial for QPCR applications.

It should be understood that additives with all or some of these features, e.g., high thermal conductivity relative to that of the base material, high particle surface area, relatively chemically inert, having lubricative properties, and/or contributing white color to the resultant compositions, are considered within the scope of this invention, even though such materials may not be specifically named herein.

Representative combinations of materials for the compositions according to the invention include compositions comprising about 95% polypropylene, by volume, and about 5% thermally-conductive polypropylene, by volume, of the total composition. Yet additional representative compositions comprise about 98% polypropylene, by volume, and about 2% boron nitride, by volume, of the total composition. As a further example, compositions according to the invention comprising about 95% polypropylene, by volume, and about 5% boron nitride, by volume, of the total composition may yield compositions having a thermal conductivity that is 20 times greater than commercial polypropylene.

The present invention further provides reaction vessels for chemical or biochemical reactions comprising the compositions according to the invention as disclosed above. The compositions according to the invention can be used to construct the reaction vessels for use in any existing thermal cycling system to improve upon that system's heat transfer capabilities and thereby increase the reaction efficiencies of such systems. Such reaction vessels are particularly suitable for use as PCR tubes.

The reaction vessels according to the invention include any container for holding sample, reagents, reaction constituents, etc., whether alone or in combination. The term “sample” as used here refers generally to the contents of the reaction vessel, including alone or in combination biological materials (including those comprising one or more nucleic acids), chemical reagents, reaction constituents, or reaction products. It is further understood that the reaction vessels according to the invention may be referred to by many names, including test tubes (also called reaction or sample tubes); microfuge tubes; sample vessels; reaction, sample, or test wells; and reaction, sample, or test containers to name a few.

The reaction vessels in accordance with the present invention need not conform to any particular shape or size. Indeed, the compositions of the invention can be used to manufacture tubes having any shape cross section, including, for example, circular, square, triangular, elliptical, pentagonal, hexagonal, octagonal, etc., as well as hybrids or combinations of such shapes. Further, the general overall three-dimensional shape of the tubes can conform to any geometry, including, for example, wedge, cone, cylinder, box, pyramid, etc., as well as hybrids or combinations of such shapes. Although some shapes may prove more advantageous than others in certain applications, the compositions of the invention can be applied to any shape container.

When a cap is used, the cap design can include a curved bottom surface. Caps can be made of the same thermally-conductive material as the tubes of the invention. However, caps containing additives, may not maintain the clarity of the base material, for example, clarified molded polypropylene material. Maximum clarity promotes the desirable quality of higher optical sensitivity by minimizing the loss of emission light from the sample along its path to the detection optics. In preferred embodiments, with a flat top surface, and a curved bottom surface, the cap provides some emission light management, like a plano-convex lens. This management acts to narrow the included angle, of the emission light from the sample. In this manner, the light may be better collected by the detection optics. The tube and cap design may work the best, in terms of optics performance, when the excitation light enters the tube from the side portion. This way, the excitation light does not get dispersed by passing through the cap. However, for some QPCR instrument designs, it may be desired to pass the excitation light through the cap, since excitation light is usually not a limiting factor in optical designs. The specific radius of curvature for the cap may be selected based on the optical system design. Another advantage to such a cap design is that, due to the small increase in section thickness, the cap will exhibit less distortion during thermal cycling. This distortion may be one of several factors, which add to optical system noise. Optical system noise reduces the sensitivity of the system for QPCR applications.

A means for sealing or closing the vessel may also be provided in accordance with the invention. Such sealing means may comprise any closure mechanism known in the art, including snap-on caps or closures, screw-type tops, rubber closures or other pop-type tops, or any other means for sealing/closing the vessel, whether partially or completely, as dictated by a specific analytical protocol. The sealing or closure means may be incorporated as part of the vessel or may be independent of the vessel, such as comprising a cap with a hinge attached to the reaction vessel or attachable to the reaction vessel. Additionally, the sealing or closure means may be constructed so as to contact the sample or contents of the vessel when in use to reduce possible interference by, for example, condensation, which might reduce the quality of optical interrogation.

For example, the top of the tube can be designed so that a suitable cap may interface with and form a seal for the reaction mixture in the tube. The cap may be transparent, like standard commercial caps for QPCR or PCR. The tube may also supports the use of a sealing film of plastic, instead of a cap, for sealing the reaction mixture in the tube. The sealing film may be a polycarbonate material, or similar. Also, the sealing film may use an adhesive layer that is pre-attached to the film during manufacture. This adhesive may be heat or pressure activated, or both. There are a variety of sealing films and adhesive materials, in addition to those listed, which may be used with the tube. Thus, the material(s) comprising the cap may be different than those comprising the tube body.

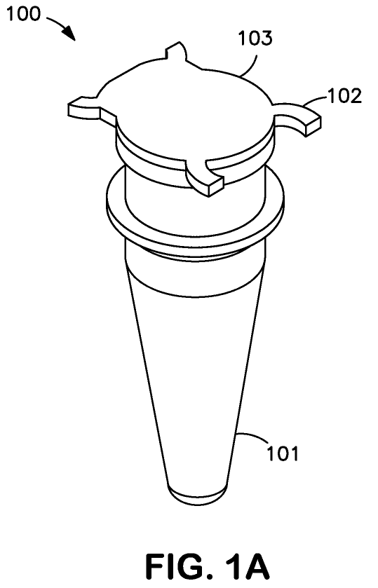

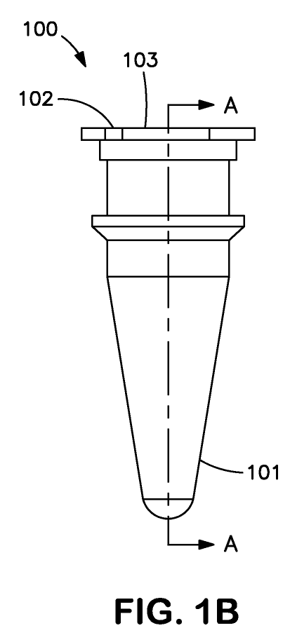

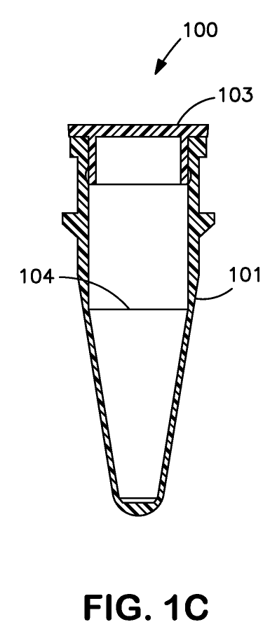

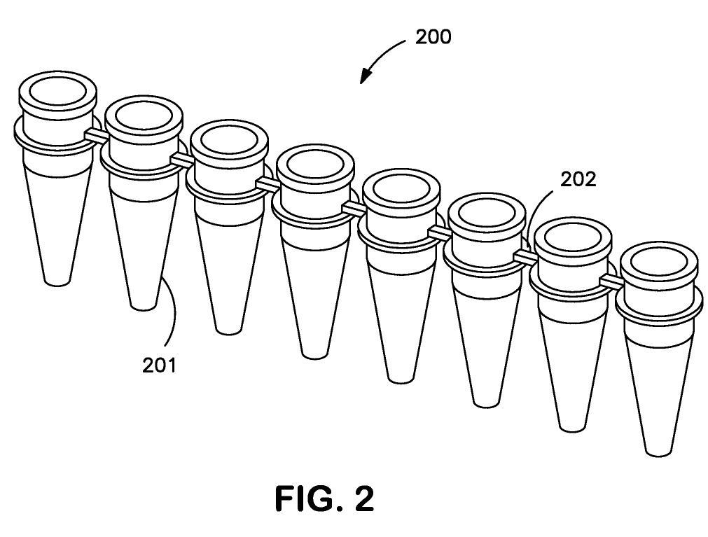

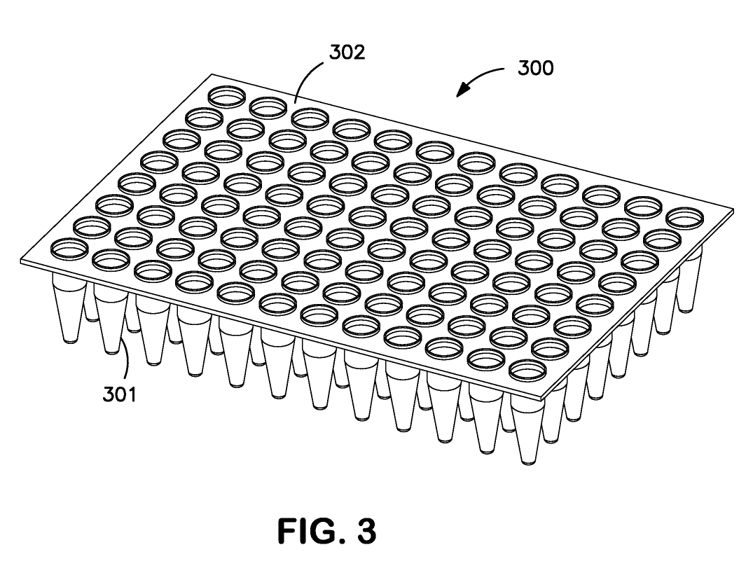

The inventive reaction vessels may be stand-alone (individual) containers, such as, for example, reaction tubes exemplified in FIGS. 1A-C, or the reaction vessels may be configured to enable simultaneous processing of multiple samples. For example, the reaction vessels may be configured to comprise a plurality of wells, such as strips of multiple tubes, including 8- and 12-tube strips, as shown by the representative 8-tube strips of FIG. 2. Other configurations include the industry-standard 96-well microtiter plates or microcards, as shown in FIG. 3. Rectangular 3×6 or 6×8 arrays are also suitable. Indeed, any array of tubes is a suitable configuration for the reaction vessels according to the invention including, for example, arrays of 18, 24, 48, 96, 384, and 1536 tubes. Any container or plurality of containers for holding the sample/reaction of interest is an appropriate configuration for the inventive reaction vessels.

One of skill in the art will understand that the compositions of the invention are useful in numerous applications and can be applied to any shape container. For convenience in understanding the present invention, only a few exemplary reaction tubes are discussed in this description. The invention, however, should not be understood as limited to these examples.

FIGS. 1A-C show various views of a representative reaction vessel 100 according to an embodiment of the invention. Reaction vessel 100 represents a standard PCR reaction tube configuration comprising standard tube 101 and cap 103, with optional supports 102. A representative sample volume height is indicated by line 104. According to the invention, standard tube 101 can comprise at least one plastic chosen from at least one of polypropylenes, polyethylenes, polyesters, polyacrylics, polyamides, polycarbonates, and vinyl polymers and at least one compound having a higher thermal conductivity than said at least one plastic, wherein said at least one compound is chosen from boron nitride, thermally-conductive polypropylene, aluminum oxide, titanium oxide, iron oxide, tin oxide, beryllium oxide, zinc oxide, aluminum nitride, boron carbide, silicon carbide, titanium carbide, graphite or carbon fibers, carbon powders, nickel powders, gold or gold coated powders, silver or silver coated powders, or combinations of nickel graphite or nickel gold additives. Cap 103 can comprise the same material as tube 101 or other cap-appropriate material. FIG. 1C shows a cross-sectional view of reaction vessel 100 as shown in FIG. 1A, in particular, a view corresponding to a cross-section cut along line A-A as shown in FIG. 1B.

FIG. 2 shows a representative reaction vessel 200 according to an embodiment of the invention. In this embodiment, reaction vessel 200 comprises eight tubes or wells 201 connected by supports 202. Tubes or wells 201 can comprise the same material as tubes 101, as described above with respect to FIGS. 1A-C.

FIG. 3 shows a representative reaction vessel 300 according to one embodiment of the invention. In this embodiment, reaction vessel 300 constitutes a 96-well plate comprising 96 tubes or wells 301 connected by support 302. Tubes or wells 301 can comprise the same material as tubes 101, as described above with respect to FIGS. 1A-C.

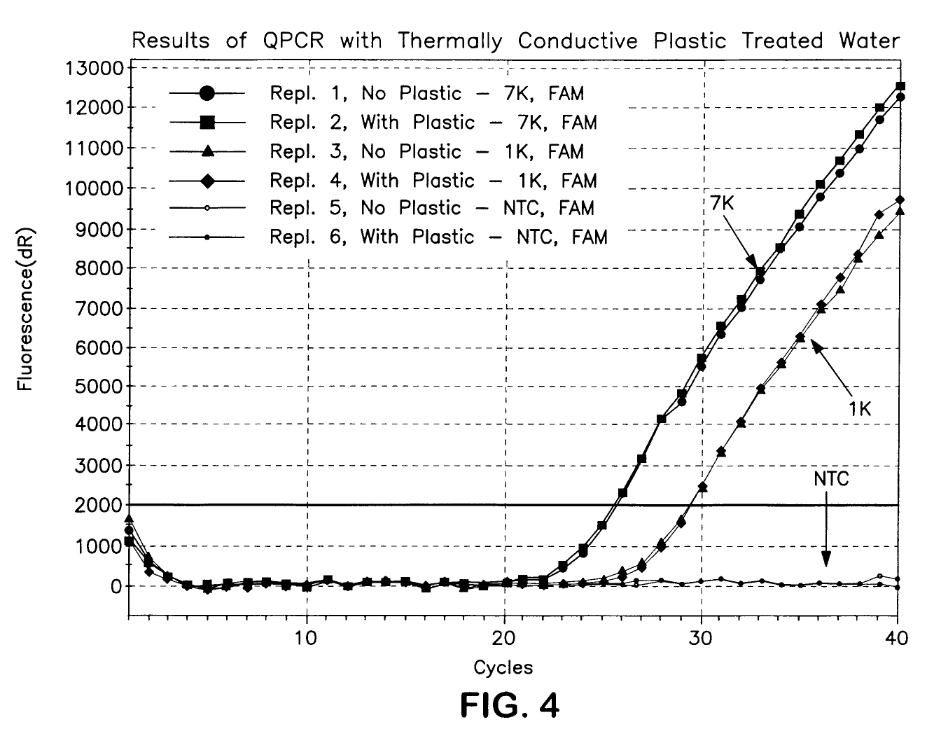

FIG. 4 is a graph showing results of QPCR run with untreated water and water treated with thermally-conductive plastic. The graph presents QPCR amplification plots from reactions generated with untreated water and water that had been treated with thermally conductive plastic. About 10 ml of water was dispensed to two separate tubes. To one tube, about 10 mg of thermally-conductive plastic shavings were added; then both tubes were boiled for about 20 minutes. Identical QPCR reaction mixes were prepared using untreated and treated water. Three different numbers of copies of human β-actin were amplified, 7000 (7K), 1000 (1K), and 0 (NTC). Results shown are an average of six replicate reactions per sample. No significant difference was observed between amplification plots of samples with the same copy number whether treated with or without thermally conductive plastic.

The compositions and reaction vessels in accordance with the invention are preferably constructed to allow for optical analysis of the sample. The compositions and reaction vessels can comprise materials having at least some transparency or can incorporate such components or materials for facilitating optical interrogation of the samples. For example, one or more walls of the reaction vessel can comprise material(s) having at least some transparency by being partially or completely constructed of transparent materials and/or transparent sections or windows can be incorporated into the reaction vessel.

In one embodiment, two smaller opposed tube sides may be used for the transmission of excitation light or emission light. Since the light will enter at the small side of the tube, it will travel through the long side of the tube, thus increasing the optical path length as compared to a similar circular or square tube. With increasing optical path length, there is increased probability that a given beam of excitation light will excite fluorescent probes in the reaction mixture rather than pass through the fluid. In this manner, an increased optical path length may increase the optical sensitivity of the tube and instrument system. The smaller tube sides may also be heated. The larger sides may be heated with a near transparent heating material (like a quartz or polyester insulated heater, or air). In this case, excitation light or emission light may enter the larger sides of the tubes.

The bottom of the tube may also be used for the transmission of excitation light or emission light. This advantage allows for flexibility in the optics design. For example, excitation light could enter through the tube bottom and emission light could exit through the smaller tube sides. This is advantageous for the optics system since the emission light will exit the tube at about a 90 degree angle to the excitation light. This angular difference may help minimize the amount of excitation light that gets through any optical filters that may result in higher background noise in the optics data. The tube design permits other angles, above and below 90 degrees, to help optimize the optics system design.

For an optic system design which provides excitation light into the bottom of the tube, the tube design may include an external radius, along the bottom of the tube, which, along with a relatively flat inside bottom tube surface, may act as a plano-convex lens, thereby helping to collimate the excitation light just before this light enters the reaction mixture. The collimation may be beneficial in that it may allow more light, as compared to non-collimated light, to enter the reaction mixture, thus increasing the sensitivity of the QPCR system.

The top of the tube may also be used for any of the previously mentioned optics functions. There may be many appropriate combinations of bottom, side, and top tube surfaces which may be used in the design of the optics system.

For an optic system design that collects emission light from the top of the tube, the tube cap may be designed with a radius along the bottom of the cap surface, and a relatively flat surface at the top of the cap. Such a shape may act as a plano-convex lens, thereby helping to collimate the emission light just before this light enters the optical detection means. The collimation may help more light to reach the detector and may reduce the amount of wavelength shifted light which enters the detector, thereby reducing optic system noise, and increasing optical system sensitivity.

The compositions and reaction vessels according to the invention may be manufactured in various ways known to those of skill in the art. For example, the compositions may be injection molded or cast. Manufacturing the reaction vessels, in particular, may be performed by constructing the reaction vessels as single units, as units having modular pieces that can be assembled or disassembled as desired, or may be constructed in pieces and then bonded together to form single unit reaction vessels. Numerous manufacturing techniques are known in the art.

The reaction vessels in accordance with the invention can optionally be coated with or may contain reagents applicable to particular reaction protocols. For example, the reaction vessels may be pre-loaded or pre-packaged with chemistry to reduce or minimize the potential for user error in mixing or adding protocol-specific reagents.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. A thermally-conductive composition comprising at least one plastic chosen from at least one of polypropylenes, polyethylenes, polyesters, polyacrylics, polyamides, polycarbonates, and vinyl polymers and comprising at least one compound having a higher thermal conductivity than said at least one plastic, wherein said at least one compound is chosen from boron nitride, thermally-conductive polypropylene, aluminum oxide, titanium oxide, iron oxide, tin oxide, beryllium oxide, zinc oxide, aluminum nitride, boron carbide, silicon carbide, titanium carbide, graphite or carbon fibers, carbon powders, nickel powders, gold or gold coated powders, silver or silver coated powders, or combinations of nickel graphite or nickel gold additives.

2. The composition according to claim 1, wherein said at least one plastic is polypropylene and said at least one compound having a higher thermal conductivity than said at least one plastic is boron nitride.

3. The composition according to claim 2, wherein said boron nitride is present in an amount of about 0.5% or more, by volume, of the total composition.

4. The composition according to claim 3, wherein said boron nitride is present in an amount ranging from about 0.5% to about 2%, by volume, of the total composition.

5. The composition according to claim 1, wherein said at least one plastic is present in an amount of about 90% or more, by volume, and said at least one compound having a higher thermal conductivity than said at least one plastic is present in an amount of about 10% or less, by volume, of the total composition.

6. The composition according to claim 5, wherein said at least one plastic is present in an amount of about 95% or more, by volume, and said at least one compound having a higher thermal conductivity than said at least one plastic is present in an amount of about 5% or less, by volume, of the total composition.

7. The composition according to claim 6, wherein said at least one plastic is present in an amount of about 98% or more, by volume, and said at least one compound having a higher thermal conductivity than said at least one plastic is present in an amount of about 2% or less, by volume, of the total composition.

8. The composition according to claim 7, wherein said at least one plastic is present in an amount ranging from about 90% to about 99.5%, by volume, and said at least one compound having a higher thermal conductivity than said at least one plastic is present in an amount ranging from about 0.5% to about 10%, by volume, of the total composition.

9. A reaction vessel for chemical or biochemical reactions comprising at least one plastic and at least one compound having a higher thermal conductivity than said at least one plastic.

10. The reaction vessel according to claim 9, wherein said at least one plastic is chosen from at least one of polypropylenes, polyethylenes, polyesters, polyacrylics, polyamides, polycarbonates, and vinyl polymers and said at least one compound having a higher thermal conductivity than said at least one plastic is chosen from boron nitride, thermally-conductive polypropylene, aluminum oxide, titanium oxide, iron oxide, tin oxide, beryllium oxide, zinc oxide, aluminum nitride, boron carbide, silicon carbide, titanium carbide, graphite or carbon fibers, carbon powders, nickel powders, gold or gold coated powders, silver or silver coated powders, or combinations of nickel graphite or nickel gold additives.

11. The reaction vessel according to claim 10, wherein said at least one plastic is polypropylene and said at least one compound having a higher thermal conductivity than said at least one plastic is boron nitride.

12. The reaction vessel according to claim 11, wherein said boron nitride is present in an amount of about 0.5% or more, by volume, of the total composition.

13. The reaction vessel according to claim 12, wherein said boron nitride is present in an amount ranging from about 0.5% to about 2%, by volume, of the total composition.

14. A PCR tube comprising at least one plastic and at least one compound having a higher thermal conductivity than said at least one plastic.

15. The PCR tube according to claim 14, wherein said at least one plastic is chosen from at least one of polypropylenes, polyethylenes, polyesters, polyacrylics, polyamides, polycarbonates, and vinyl polymers and said at least one compound having a higher thermal conductivity than said at least one plastic is chosen from boron nitride, thermally-conductive polypropylene, aluminum oxide, titanium oxide, iron oxide, tin oxide, beryllium oxide, zinc oxide, aluminum nitride, boron carbide, silicon carbide, titanium carbide, graphite or carbon fibers, carbon powders, nickel powders, gold or gold coated powders, silver or silver coated powders, or combinations of nickel graphite or nickel gold additives.

16. The PCR tube according to claim 15, wherein said at least one plastic is polypropylene and said at least one compound having a higher thermal conductivity than said at least one plastic is boron nitride.

17. The PCR tube according to claim 16, wherein said boron nitride is present in an amount of about 0.5% or more, by volume, of the total composition.

18. The reaction vessel according to claim 17, wherein said boron nitride is present in an amount ranging from about 0.5% to about 2%, by volume, of the total composition.
